(19) United States
(12) Patent Application Publication
(10) Pub. No.: US 2008/0185961 A1
(43) Pub. Date: Aug. 7, 2008

(54) PLASMA DISPLAY PANEL AND PLASMA DISPLAY DEVICE INCLUDING THE PLASMA DISPLAY PANEL

(76) Inventor: Chong-Gi Hong, Yongin-si (KR)

Correspondence Address: CHRISTIE, PARKER & HALE, LLP, PO BOX 7068, PASADENA, CA, 91109-7068, US

(21) Appl. No.: 12/026,496

(22) Filed: Feb. 5, 2008

(30) Foreign Application Priority Data
Feb. 7, 2007 (KR) 10-2007-0012672

(51) Int. Cl. H01J 17/49

(52) U.S. Cl. 313/584

(57) ABSTRACT

A plasma display panel capable of improving a black area ratio and a bright room contrast and reducing a reflected luminance by coloring different layers in the plasma display panel is provided. The plasma display panel includes: a rear substrate; a front substrate colored with a first chromatic color and facing the rear substrate; barrier ribs disposed between the front and rear substrates and defining discharge cells; address electrodes extending in a first direction on the rear substrate and corresponding to the discharge cells; phosphor layers disposed in the discharge cells, wherein at least one of the phosphor layers is colored with a second chromatic color; display electrodes extending in a second direction crossing the first direction on the front substrate and corresponding to the discharge cells; and a front dielectric layer disposed on the front substrate to cover the display electrodes and colored with a third chromatic color.

### CROSS-REFERENCE TO RELATED APPLICATION

This application claims priority to and the benefit of Korean Patent Application No. 10-2007-0012672, filed on Feb. 7, 2007, in the Korean Intellectual Property Office, the entire content of which is incorporated herein by reference.

### BACKGROUND OF THE INVENTION

1. Field of the Invention

The present invention relates to a plasma display panel, and more particularly, to a plasma display panel having an improved black area ratio and bright room contrast.

2. Description of the Related Art

In general, a plasma display panel uses vacuum ultra-violet (VUV) rays emitted from plasma obtained through a gas discharge. The VUV rays excite a phosphor material. Visible light is generated by stabilizing the excited phosphor material. The visible light has a color of red, green, or blue depending on types of phosphor materials. Images are displayed by suitably combining the visible light of red, green, or blue.

For example, an alternating current (AC) type plasma display panel has a structure in which address electrodes are formed on a rear substrate and covered with a dielectric layer. Barrier ribs are formed on the dielectric layer in a stripe shape. The barrier ribs define discharge cells. Fluorescent layers are formed in the discharge cells. In addition, inert gas is injected into the discharge cells to make environment in which the discharge is easily carried out.

Display electrodes, which cross the address electrodes, are formed on a front substrate that faces the rear substrate. The display electrodes are sequentially covered with the dielectric layer and a protective layer.

The discharge cells are formed at positions where the address electrodes on the rear substrate cross the display electrodes on the front substrate. In the plasma display panel, the plurality of discharge cells are typically formed in a matrix or stripe shape.

In a bright condition, (e.g., a bright room condition), external light is incident into the panel. A part of the incident light is absorbed in the panel, and the rest of the incident light is reflected. The reflected light overlaps the visible light generated in the discharge cells. As a result, the image display performance of the plasma display panel deteriorates.

Various attempts for improving the aforementioned image display performance of the plasma display panel have been made. The methods for improving the image display performance include a method of improving a contrast and reducing a reflected luminance by increasing a black area ratio and a method of improving a luminance of the panel by increasing emission efficiency.

### SUMMARY OF THE INVENTION

An exemplary embodiment according to the present invention provides a plasma display panel of which black area ratio and bright room contrast are improved without additional components.

According to an aspect of an exemplary embodiment of the present invention, there is provided a plasma display panel including: a rear substrate; a front substrate facing the rear substrate, the first substrate being colored with a first chromatic color; barrier ribs disposed between the front and rear substrates, the barrier ribs defining discharge cells; address electrodes extending in a first direction on the rear substrate and corresponding to the discharge cells; a plurality of phosphor layers, disposed in the discharge cells, wherein at least one of the phosphor layers is colored with a second chromatic color; display electrodes extending in a second direction crossing the first direction on the front substrate and corresponding to the discharge cells; and a front dielectric layer disposed on the front substrate to cover the display electrodes and colored with a third chromatic color.

In the above aspect of an exemplary embodiment of the present invention, the first chromatic color and the third chromatic color may be complementary colors with respect to each other. In addition, the first chromatic color may be selected from shades of yellow red, and the third chromatic color may be selected from shades of blue. In addition, the front substrate may be colored with the first chromatic color by adding at least one of copper (Cu), antimony (Sb), or chromium (Cr) to the front substrate. In addition, the front dielectric layer may be colored with the third chromatic color by adding at least one of manganese (Mn), nickel (Ni), or cobalt (Co) to the front dielectric layer.

In addition, the second chromatic color and the third chromatic color may be in a complementary color relationship. Further, the second chromatic color may be selected from shades of yellow red, and the third chromatic color may be selected from shades of blue. In addition, said at least one of the phosphor layers may be colored with the second chromatic color by adding at least one of copper (Cu), antimony (Sb), or chromium (Cr) to said at least one of the phosphor layers. The phosphor layers may include a red phosphor layer adapted to emit visible light of red, a green phosphor layer adapted to emit visible light of green, and a blue phosphor layer adapted to emit visible light of blue, and at least one phosphor layer among the red, green, and blue phosphor layers may be colored with one color among red, green, and blue colors.

According to another aspect of an exemplary embodiment of the present invention, there is provided a plasma display panel including: a rear substrate; a front substrate facing the rear substrate, the front substrate being colored with a first chromatic color; barrier ribs disposed between the front and rear substrates, the barrier ribs being colored with a fourth chromatic color and defining discharge cells; address electrodes extending in a first direction on the rear substrate and corresponding to the discharge cells; a plurality of phosphor layers disposed in the discharge cells, wherein at least one of the phosphor layers is colored with a second chromatic color; display electrodes extending in a second direction crossing the first direction on the front substrate and corresponding to the discharge cells; and a front dielectric layer disposed on the front substrate to cover the display electrodes and colored with a third chromatic color.

In the above aspect of an exemplary embodiment of the present invention, the third chromatic color and the fourth chromatic color may be complementary colors with respect to each other.

According to another exemplary embodiment, a plasma display device includes any one of the plasma display panels of the exemplary embodiments according to the present invention.

### BRIEF DESCRIPTION OF THE DRAWINGS

The above and other features and aspects of the present invention will become more apparent by describing in detail exemplary embodiments thereof with reference to the attached drawings in which:

FIG. 1 is a partially exploded perspective view illustrating a plasma display panel according to a first embodiment of the present invention;

FIG. 2 is a cross sectional view taken along the line II-II of FIG. 1;

FIG. 3 is a partial top plan view illustrating an image display region of the plasma display panel according to the first embodiment of the present invention;

FIG. 4 is a hue circle for illustrating complementary color relations;

FIG. 5 is a partially exploded perspective view illustrating a plasma display panel according to a second embodiment of the present invention;

FIG. 6 is a partial top plan view illustrating an image display region of the plasma display panel according to the second embodiment of the present invention; and

FIG. 7 is a block diagram of a plasma display device incorporating any one of the plasma display panels of exemplary embodiments according to the present invention.

### DETAILED DESCRIPTION

The present invention will now be described more fully hereinafter with reference to the accompanying drawings, in which exemplary embodiments of the invention are shown. As those skilled in the art would realize, the described embodiments may be modified in various different ways, all without departing from the spirit or scope of the present invention.

There may be parts shown in the drawings, or parts not shown in the drawings, that are not discussed in the specification as they are not essential to a complete understanding of the invention. Like reference numerals designate like elements throughout the specification.

Hereinafter, a plasma display panel according to exemplary embodiments of the present invention will be described in detail.

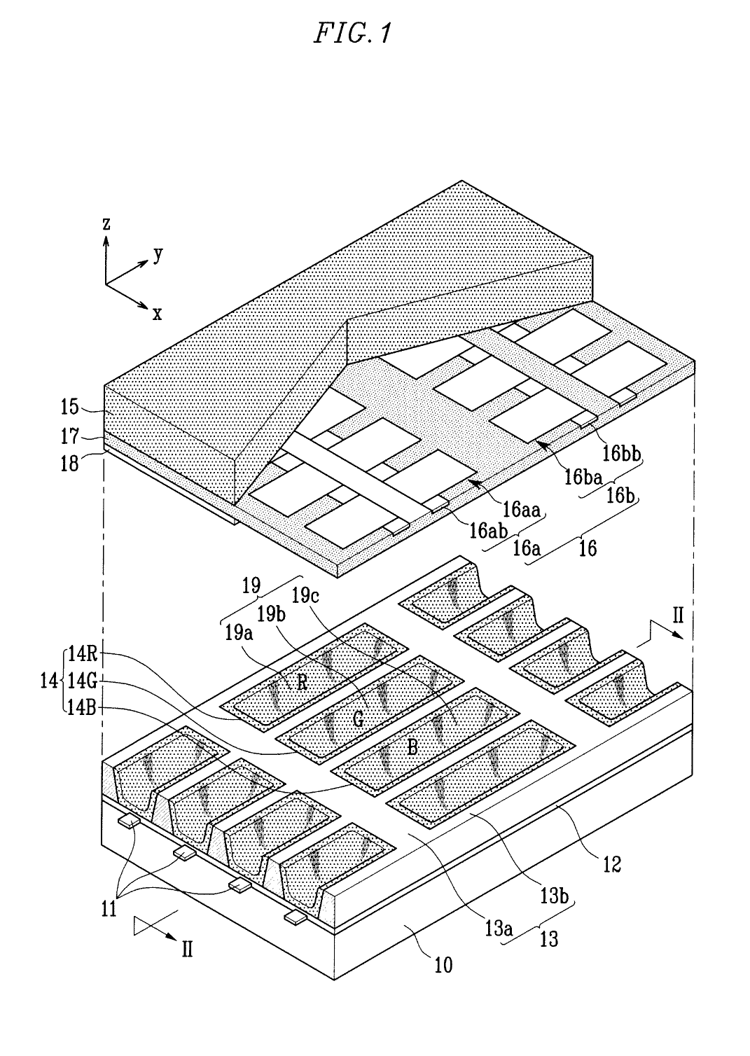

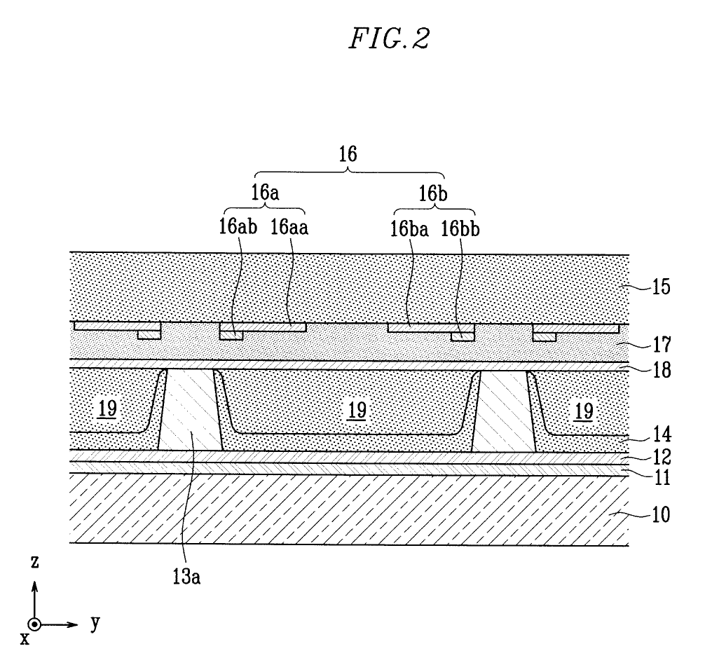

FIG. 1 is a partially exploded perspective view illustrating a plasma display panel according to a first embodiment of the present invention. FIG. 2 is a cross sectional view taken along the line II-II of FIG. 1.

Referring to FIGS. 1 and 2, the plasma display panel according to the first embodiment of present invention includes rear and front substrates 10 and 15, discharge cells 19 which are defined by barrier ribs 13 between the rear and front substrates 10 and 15, and address and display electrodes 11 and 16 which are formed corresponding to the discharge cells 19.

The rear substrate 10 faces the front substrate 15, and the rear and front substrates 10 and 15 are parallel with each other at a distance (e.g., a predetermined gap between the substrates). The address electrodes 11 extend in a first direction (i.e., a y-axis direction of FIG. 1) on an upper surface of the rear substrate 10. In addition, the address electrodes 11 are parallel with one another, and are spaced apart from one another by an interval (e.g., a predetermined interval).

A rear dielectric layer 12 is formed on the upper surface (FIG. 2) of the rear substrate 10. The address electrodes 11 are covered with the rear dielectric layer 12. The address electrodes 11 may be made of a metal that has a high conductivity, such as silver (Ag). In addition, since the address electrodes 11 are chemically stable, the address electrodes 11 may not react with the rear dielectric layer 12 and the rear substrate 10.

In addition, the display electrodes 16 extend in a second direction (i.e., an x-axis direction of FIG. 1) on a lower surface of the front substrate 15. The display electrodes 16 are parallel with one another, and are spaced apart from one another by an interval (e.g., a predetermined interval).

The display electrodes 16 include sustain electrodes 16a and scan electrodes 16b corresponding to the discharge cells 19. The sustain electrodes 16a include transparent electrodes 16aa and bus electrodes 16ab. The scan electrodes 16b include transparent electrodes 16ba and bus electrodes 16bb. The bus electrodes 16ab and 16bb are formed under the transparent electrodes 16aa and 16ba, respectively. The transparent electrodes 16aa and 16ba are spaced apart from one another by a distance (e.g., a predetermined distance) to form a discharge gap.

The transparent electrodes 16aa and 16ba are made of a transparent material such as indium tin oxide (ITO) to transmit the visible light. Since the transparent electrodes 16aa and 16ba have a high resistance, the transparent electrodes 16aa and 16ba have a low conductivity. On the other hand, the bus electrodes 16ab and 16bb are made of a metal (for example, silver (Ag) or Cr/Cu/Cr), which has a high conductivity, to apply a voltage to the transparent electrodes 16aa and 16ba.

As shown in FIG. 2, a front dielectric layer 17 is formed under the front substrate 15. The display electrodes 16 are covered with the front dielectric layer 17. The front dielectric layer 17 protects the display electrodes 16 against discharge. The discharge is carried out in the discharge cells 19 by accumulating wall charges in the front dielectric layer 17.

The front dielectric layer 17 is further covered with a protective layer 18. The protective layer 18 is made of a transparent material. The protective layer 18 transmits visible light emitted from the phosphor layer 14 and protects the front dielectric layer 17 against discharge. The protective layer 18 lowers a firing voltage level by increasing a secondary electron emission coefficient. For example, the protective layer 18 may be made of magnesium oxide (MgO). The magnesium oxide (MgO) has a characteristic of transmitting visible light.

The barrier ribs 13 are formed between the protective layer 18 and the rear dielectric layer 12 to define the discharge cells 19. The barrier ribs 13 include transversal barrier ribs 13a and longitudinal barrier ribs 13b.

The transversal barrier ribs 13a extend in the second direction (i.e., the x-axis direction of FIG. 1). The longitudinal barrier ribs 13b extend in the first direction (i.e., the y-axis direction of FIG. 1). The longitudinal barrier ribs 13b cross and intersect the transversal barrier ribs 13a. In the first embodiment of the present invention, the longitudinal and transversal barrier ribs 13a and 13b define discharge cells 19 in a matrix shape.

The discharge cells 19 according to other embodiments of the present invention may have various shapes such as a stripe or delta shape instead of the matrix shape. The barrier ribs 13 having the matrix shape according to the embodiment of the present invention prevent crosstalks among the discharge cells 19 when the discharge is carried out. The barrier ribs 13 provide surfaces that are coated with the phosphor layer 14.

As shown in FIG. 1, the phosphor layers 14 are classified according to emission characteristics of visible lights emitted using VUV rays. Specifically, the phosphor layers 14 include a red phosphor layer 14R which emits visible light of red, a green phosphor layer 14G which emits visible light of green, and a blue phosphor layer 14B which emits visible light of blue.

One pixel includes a set of three discharge cells 19 including a discharge cell 19a in which the red phosphor layer 14R is formed, a discharge cell 19b in which the green phosphor layer 14G is formed, and a discharge cell 19c in which the blue phosphor layer 14B is formed. In order to improve luminance, white based powders with high reflectance may be included in the phosphor layers 14.

The discharge cells 19 are filled with a discharge gas that is an inert gas (for example, a mixture of neon (Ne) and xenon (Xe)). The discharge gas generates gas discharge between the sustain electrodes 16a and scan electrodes 16b. Plasma is generated through the gas discharge. The VUV rays generated from the plasma excite the phosphor layers 14. Visible light is emitted by stabilizing the excited phosphor layers 14.

The front substrate 15 according to one embodiment of the present invention is colored with a first color (e.g., a first chromatic color). At least one of the phosphor layers 14 is colored with a second color (e.g., a second chromatic color). The front dielectric layer 17 is colored with a third color (e.g., a third chromatic color). In addition, the first to third colors are in a subtractive mixture relationship. In one embodiment, all of the phosphor layers 14 are colored with the second color. In other embodiments, one or more, but not all, of the phosphor layers 14, may be colored with the second color. At least one phosphor layer among the red, green, and blue phosphor layers 14R, 14G and 14B, may be colored with one color among red, green, and blue colors.

By way of example, in one embodiment of the present invention, the first color of the front substrate 15 and the third color of the front dielectric layer 17 are in a primary complementary color relationship. The third color of the front dielectric layer 17 and the second color of the phosphor layers 14 are in a secondary complementary color relationship. As such, the front substrate 15, the front dielectric layer 17, and the phosphor layers 14 are in a double complementary color relationship.

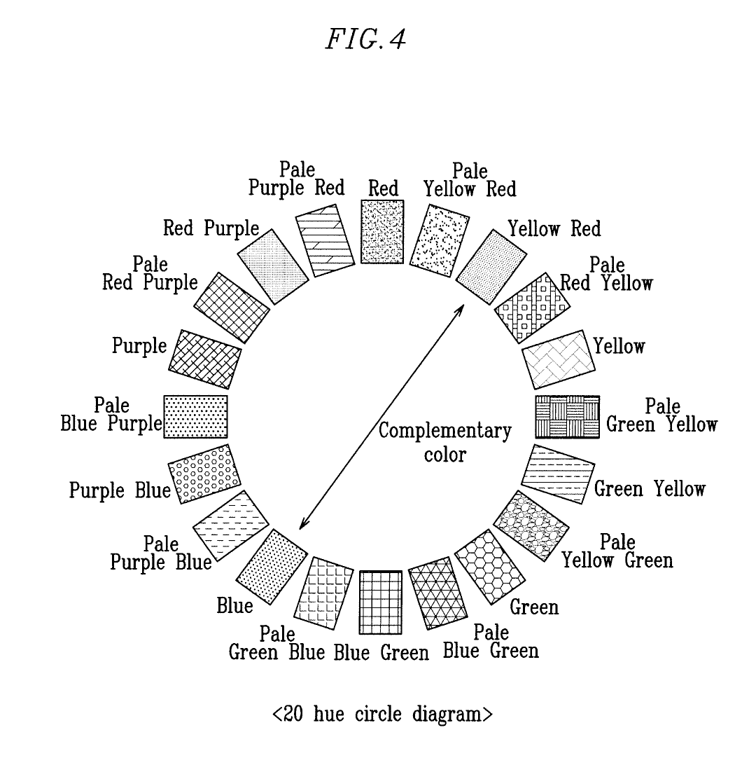

Types and relationships among the first color of the front substrate 15, the second color of the phosphor layers, and the third color of the front dielectric layer 17 will be described in detail with reference to FIG. 4.

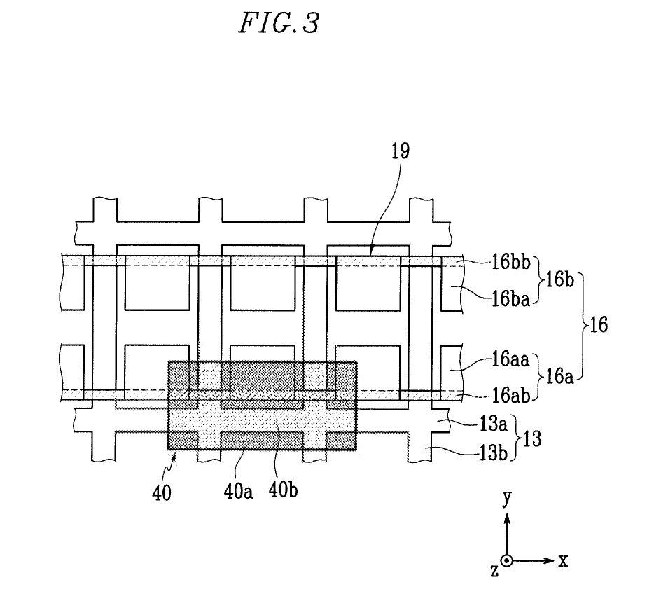

FIG. 3 is a partial top plan view illustrating an image display region of the plasma display panel according to the first embodiment of the present invention.

The first embodiment of the present invention will be described in detail with reference to FIG. 3. Like reference numerals designate like elements throughout the specification. Repeated descriptions will be omitted.

As shown in FIG. 3, the sustain and scan electrodes 16a and 16b form pairs and extend in the second direction (i.e., the x-axis in FIG. 3) along the discharge cells 19. The bus electrodes 16ab and 16bb are formed under the transparent electrodes 16aa and 16ba, respectively.

The plasma display panel includes an image display region 40 on which images are displayed. In FIG. 3, only a part of the image display region 40 is shown. The image display region 40 includes a first region 40a, where the florescent layers 14 are visible through the front substrate 15 and the front dielectric layer 17, and a second region 40b, where the barrier ribs 13 are visible through the front substrate 15 and the front dielectric layer 17.

According to one embodiment of the present invention, when the first color of the front substrate 15 is blue, and the third color of the front dielectric layer 17 is yellow red, a part where the front substrate 15 overlaps the front dielectric layer 17 appears black or substantially black.

In addition, when the third color of the front dielectric layer 17 is yellow red, and the second color of the phosphor layers 14 is blue, a part where the front dielectric layer 17 overlaps the phosphor layers 14 appears black or substantially black.

Accordingly, a black area ratio of the plasma display panel increases, and the bright room contrast is improved by reducing the reflected luminance of the plasma display panel. Specifically, in one embodiment of the present invention, the second region 40b is in a single complementary color relationship due to the first and third colors. The first region 40a is in a double complementary color relationship due to the first and third colors and the third and second colors. Accordingly, the first region 40a appears darker black than the second region 40b.

According to one embodiment of the present invention, in order to color the front substrate 15, the phosphor layers 14, and the front dielectric layer 17 with the first to third colors, respectively, coloring agents may be added to the front substrate 15, the phosphor layers 14, and the front dielectric layer 17. The coloring agents may coat the surfaces of the front substrate 15, the phosphor layers 14, and the front dielectric layer 17 or may be mixed into the respective raw materials used to form the front substrate 15, the phosphor layers 14, and the front dielectric layer 17.

In order to be colored with blue, a material selected among manganese (Mn), nickel (Ni), cobalt (Co), and combinations thereof, may be added to the layer to be colored with blue or may coat the layer to be colored with blue. In order to be colored with yellow red, a material selected among copper (Cu), antimony (Sb), chromium (Cr), and combinations thereof, may be added to the layer to be colored with yellow red or may coat the layer to be colored with yellow red.

In addition, the phosphor layers 14 include the red phosphor layer 14R which emits visible light of red, the green phosphor layer 14G which emits visible light of green, and the blue phosphor layer 14B which emits visible light of blue. The visible lights are obtained using VUV rays. At least one phosphor layer among the red, green, and blue phosphor layers 14R, 14G, and 14B may be colored with one color among red, green, and blue. For example, color purity may increase by coloring the red phosphor layer 14R with red. The color purity may increase by coloring the green phosphor layer 14G with green. The color purity may increase by coloring the blue phosphor layer 14B with blue.

In one embodiment of the present invention, coloring agents may be added to the phosphor layers 14. In order not to deteriorate the emission characteristic of the phosphor layers 14, a particle size of the coloring agents may be less than that of the phosphor materials. The coloring agents may coat the surfaces of the phosphor particles or may be mixed into the phosphor particles. In addition, the coloring agents may coat the surfaces of the phosphor layers 14.

FIG. 4 is a hue circle (e.g., a Munsell color system) for illustrating complementary color relationship.

Two colors which are mixed to form black, white, or gray are in a complementary color relationship. As shown in FIG. 4, blue and yellow red are in a complementary color relationship. Red and cyan (i.e., blue green) are in a complementary color relationship. Purple and green yellow are in a complementary color relationship. Although black and white are not shown in the hue circle, black and white are in a complementary relationship. An infinite number of pairs of colors are in respective complementary relationships.

Even when colors are not in a complementary relationship, when the colors which are substantially in the complementary relationship are subtractively mixed, the subtractive color mixture appears substantially black. For example, in FIG. 4, yellowish red (i.e., pale yellow red) and blue are not in a complementary color relationship. However, yellowish red is adjacent to yellow red that is the complementary color of blue. Accordingly, blue and yellowish red together appear substantially black when they are subtractively mixed.

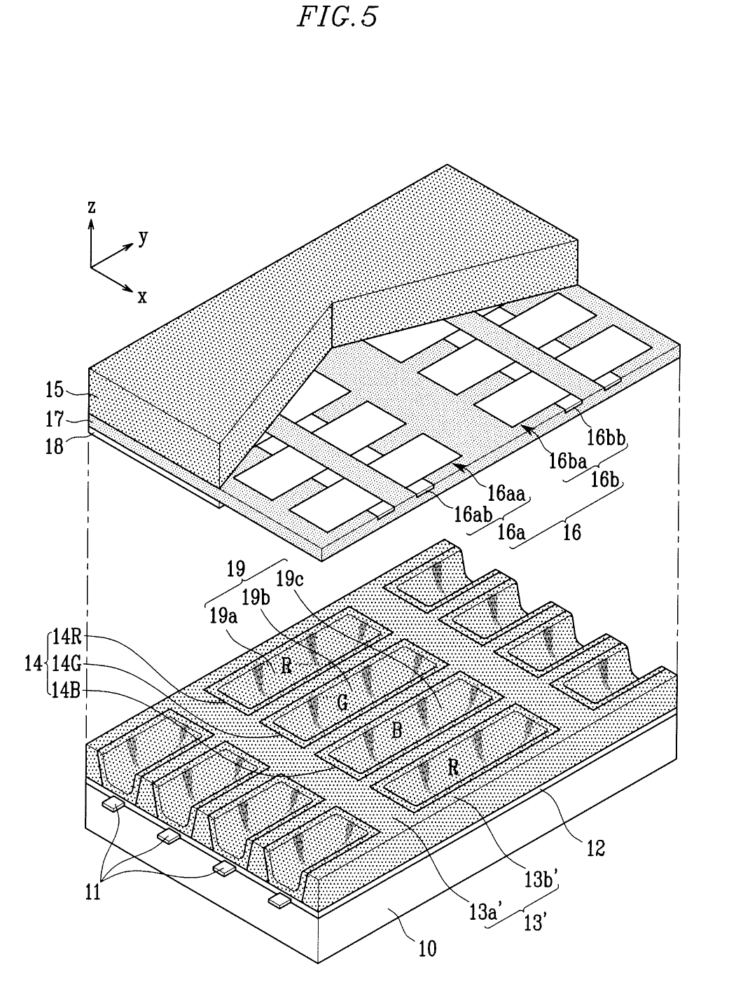

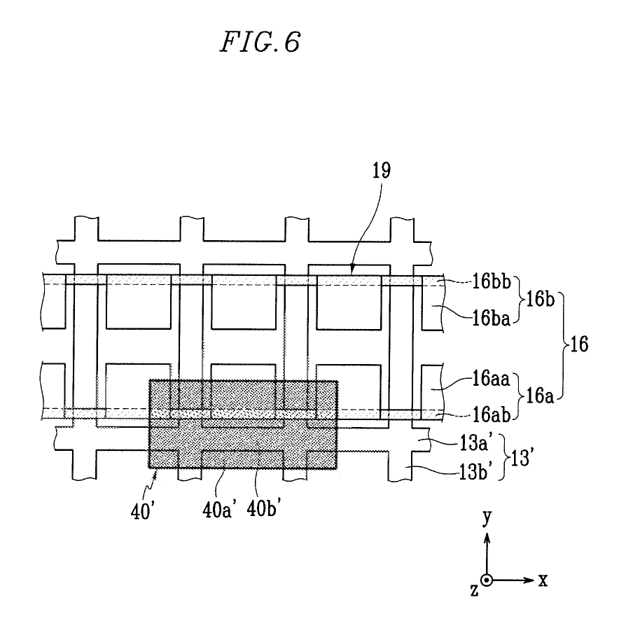

FIG. 5 is a partially exploded perspective view illustrating a plasma display panel according to a second embodiment of the present invention. FIG. 6 is a partial top plan view illustrating an image display region of the plasma display panel according to the second embodiment of the present invention.

The second embodiment of the present invention will be described in detail with reference to FIGS. 5 and 6. Like reference numerals designate like elements throughout the specification. Descriptions that are mere repeats of the descriptions given in reference to the first embodiment will be omitted.

Unlike FIG. 1, in FIG. 5, barrier ribs 13′ (including barrier ribs 13a′ and 13b′) are colored with a fourth color (e.g., fourth chromatic color). In general, the barrier ribs 13′ contain glass powders with a low melting-point, an organic solvent (e.g., resin, etc), or a peeler (e.g., aluminum or metal powders). In one embodiment of the present invention, in order to increase the black area ratio, a coloring agent is added to the barrier ribs 13′.

When the barrier ribs 13′ are colored with white, the black area ratio of the plasma display panel decreases. When the black area ratio decreases, the contrast decreases, and the reflected luminance increases. On the other hand, the fourth color of the barrier ribs 13′ according to one embodiment of the present invention and the third color of the front dielectric layer 17 are in a subtractive mixture relationship.

As shown in FIG. 6, the plasma display panel in the second embodiment includes an image display region 40′ on which images are displayed. In FIG. 6, only a part of the image display region 40′ is shown. The image display region 40′ includes a first region 40a′ where the phosphor layers 14 are visible through the front substrate 15 and the front dielectric layer 17 and a second region 40b′ where the barrier ribs 13′ are visible through the front substrate 15 and the front dielectric layer 17.

As shown in FIG. 6, when the first color of the front substrate 15 is blue, and the third color of the front dielectric layer 17 is yellow red, a part where the front substrate 15 overlaps the front dielectric layer 17 appears black or substantially black.

In addition, when the third color of the front dielectric layer 17 is yellow red, and the second color of the phosphor layers 14 is blue, a part where the front dielectric layer 17 overlaps the phosphor layers 14 appears black or substantially black. In addition, when the third color of the front dielectric layer 17 is yellow red, and the fourth color of the barrier ribs 13′ is blue, a part where the front dielectric layer 17 overlaps the barrier ribs 13′ appears black or substantially black.

Accordingly, a black area ratio of the plasma display panel increases, and the bright room contrast is improved by reducing the reflected luminance of the plasma display panel. Specifically, in the second embodiment of the present invention, both the first region 40a′ and the second region 40b′ are in a double complementary color relationship.

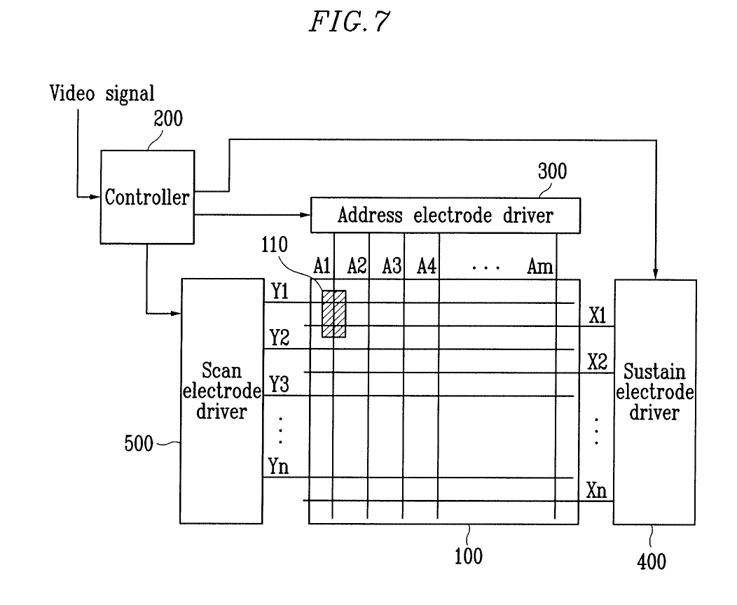

Referring now to FIG. 7, a plasma display device according to an exemplary embodiment of the present invention includes a plasma display panel (PDP) 100, a controller 200, an address electrode driver 300, a sustain electrode driver 400, and a scan electrode driver 500. The sustain electrode driver 400 and/or the scan electrode driver 500 may also be referred to as a display electrode driver, either individually or together. The PDP 100 may be any one of the PDPs disclosed in FIGS. 1-3 and 5-6 according to embodiments of the present invention.

The PDP 100 includes a plurality of address electrodes A1 to Am (hereinafter, referred to as “A electrodes”) extending in a column direction, and a plurality of sustain and scan electrodes X1 to Xn and Y1 to Yn (hereinafter, referred to as “X electrodes” and “Y electrodes”) extending in a row direction in pairs. The X electrodes and the Y electrodes may also be referred to as display electrodes. In general, the X electrodes X1 to Xn respectively correspond to the Y electrodes Y1 to Yn, and the Y and X electrodes Y1 to Yn and X1 to Xn are arranged to cross the A electrodes A1 to Am. In this case, a discharge space at a crossing region of the A electrodes A1 to Am and the X and Y electrodes X1 to Xn and Y1 to Yn forms a discharge cell 110. One or more of the phosphors formed in the discharge cells are colored with the second color (e.g., the second chromatic color) in exemplary embodiments according to the present invention.

The controller 200 receives an external video signal, outputs driving control signals, divides a frame into a plurality of subfields having respective brightness weight values, and drives them. Each subfield has at least an address period and a sustain period. The A, X, and Y electrode drivers 300, 400, 500 respectively apply driving voltages to the A electrodes A1 to Am, the X electrodes X1 to Xn, and the Y electrodes Y1 to Yn in response to the driving control signals from the controller 200. The driving voltages provided to the A electrodes may also be referred to as address signals the driving voltages provided to the X electrodes and the Y electrodes may also be referred to as display signals, which may include sustain signals and/or scan signals.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

As described above, in the plasma display panel according to an embodiment of the present invention, the black area ratio of the panel and the bright room contrast can be improved by coloring the front substrate, the front dielectric layer, and one or more of the phosphor layers with the first, third, and second colors (e.g., the first, third, and second chromatic colors), respectively.

In addition, the black area ratio of the panel and the bright room contrast can be further improved in another embodiment by coloring the front substrate, the front dielectric layer, one or more of the phosphor layers, and the barrier ribs with the first, third, second, and fourth colors (e.g., the first, third, second, and fourth chromatic colors), respectively.

Further, the black area ratio of the panel and the bright room contrast can be further improved in another embodiment by coloring the front dielectric layer, one or more of the phosphor layers, and the barrier ribs with the third, second, and fourth colors (e.g., the third, second, and fourth chromatic colors), respectively.

What is claimed is:

1. A plasma display panel comprising:
a rear substrate;
a front substrate facing the rear substrate, the first substrate being colored with a first chromatic color;
barrier ribs disposed between the front and rear substrates, the barrier ribs defining discharge cells;
address electrodes extending in a first direction on the rear substrate and corresponding to the discharge cells;
a plurality of phosphor layers disposed in the discharge cells, wherein at least one of the phosphor layers is colored with a second chromatic color;
display electrodes extending in a second direction crossing the first direction on the front substrate and corresponding to the discharge cells; and
a front dielectric layer disposed on the front substrate to cover the display electrodes and colored with a third chromatic color.

2. The plasma display panel of claim 1, wherein the first chromatic color and the third chromatic color are complementary colors with respect to each other.

3. The plasma display panel of claim 2, wherein the first chromatic color is selected from shades of yellow red, and the third chromatic color is selected from shades of blue.

4. The plasma display panel of claim 3, wherein the front substrate is colored with the first chromatic color by adding at least one of copper (Cu), antimony (Sb), or chromium (Cr) to the front substrate.

5. The plasma display panel of claim 3, wherein the front dielectric layer is colored with the third chromatic color by adding at least one of manganese (Mn), nickel (Ni), or cobalt (Co) to the front dielectric layer.

6. The plasma display panel of claim 1, wherein the first chromatic color and the third chromatic color are subtractive mixed with each other to appear black or substantially black.

7. The plasma display panel of claim 6, wherein the second chromatic color and the third chromatic color are subtractively mixed with each other to appear black or substantially black.

8. The plasma display panel of claim 1, wherein the second chromatic color and the third chromatic color are complementary colors with respect to each other.

9. The plasma display panel of claim 8, wherein the second chromatic color is selected from shades of yellow red, and the third chromatic color is selected from shades of blue.

10. The plasma display panel of claim 9, wherein said at least one of the phosphor layers is colored with the second chromatic color by adding at least one of copper (Cu), antimony (Sb), or chromium (Cr) to said at least one of the phosphor layers.

11. The plasma display panel of claim 1, wherein the phosphor layers include a red phosphor layer adapted to emit visible light of red, a green phosphor layer adapted to emit visible light of green, and a blue phosphor layer adapted to emit visible light of blue, and at least one phosphor layer among the red, green, and blue phosphor layers is colored with one color among red, green, and blue colors.

12. The plasma display panel of claim 1, wherein the second chromatic color and the third chromatic color are subtractively mixed with each other to appear black or substantially black.

13. A plasma display panel comprising:
a rear substrate;
a front substrate facing the rear substrate, the front substrate being colored with a first chromatic color;
barrier ribs disposed between the front and rear substrates, the barrier ribs being colored with a fourth chromatic color and defining discharge cells;
address electrodes extending in a first direction on the rear substrate and corresponding to the discharge cells;
a plurality of phosphor layers disposed in the discharge cells, wherein at least one of the phosphor layers is colored with a second chromatic color;
display electrodes extending in a second direction crossing the first direction on the front substrate and corresponding to the discharge cells; and
a front dielectric layer disposed on the front substrate to cover the display electrodes and colored with a third chromatic color.

14. The plasma display panel of claim 13, wherein the third chromatic color and the fourth chromatic color are complementary colors with respect to each other.

15. The plasma display panel of claim 13, wherein the first chromatic color and the third chromatic color are subtractively mixed with each other to appear black or substantially black.

16. The plasma display panel of claim 15, wherein the second chromatic color and the third chromatic color are subtractively mixed with each other to appear black or substantially black.

17. The plasma display panel of claim 15, wherein the third chromatic color and the fourth chromatic color are subtractively mixed with each other to appear black or substantially black.

18. A plasma display device comprising a plasma display panel, and further comprising:
an address electrode driver adapted to provide address signals to the plasma display panel;
at least one display electrode driver adapted to provide display signals to the plasma display panel; and
a controller adapted to convert a video signal to driving control signals and to provide the driving control signals to the address electrode driver and said at least one display electrode driver,
wherein the plasma display panel comprises:
a rear substrate;
a front substrate facing the rear substrate, the first substrate being colored with a first chromatic color;
barrier ribs disposed between the front and rear substrates, the barrier ribs defining discharge cells;
address electrodes extending in a first direction on the rear substrate and corresponding to the discharge cells;
a plurality of phosphor layers disposed in the discharge cells, wherein at least one of the phosphor layers is colored with a second chromatic color;
display electrodes extending in a second direction crossing the first direction on the front substrate and corresponding to the discharge cells; and
a front dielectric layer disposed on the front substrate to cover the display electrodes and colored with a third chromatic color.

19. The plasma display device of claim 18, wherein the barrier ribs are colored with a fourth chromatic color.

20. The plasma display device of claim 19, wherein the third chromatic color is subtractively mixed with at least one of the first chromatic color, the second chromatic color or the fourth chromatic color to appear black or substantially black.
